(19) United States
(12) Patent Application Publication
(10) Pub. No.: US 2012/0116943 A1
(43) Pub. Date: May 10, 2012

(54) System and Method for Processing Contracts for Conditional and Unconditional Forward Sales of Retail Goods

(76) Inventor: Bruce D. Abramson, Las Vegas, NV (US)

(21) Appl. No.: 13/225,085

(22) Filed: Sep. 2, 2011

Related U.S. Application Data
(60) Provisional application No. 61/474,744, filed on Apr. 13, 2011.
(60) Provisional application No. 61/410,316, filed on Nov. 4, 2010.

(51) Int. Cl. G06Q 40/04

(52) U.S. Cl. 705/37

(57) ABSTRACT

The invention is directed to a system and method for facilitating the completion of contracts for conditional or unconditional forward sales (CCUFSs) of retail goods via a CCUFS exchange, in combination with a distribution network for taking delivery on completed contracts. The system comprises a CCUFS exchange comprising a networked computing device and at least one database, and a retail distribution network comprising a plurality of retail distribution points. Using the CCUFS exchange, users may post offers to buy and sell on basic futures contracts, put and call options, and secondary sales, as well as more complex derivatives. Offers having similar terms may be pooled together and an inventory rebalancing module may redistribute retail goods or money to sellers that over-deliver or under-deliver.

### CROSS-REFERENCE TO RELATED APPLICATIONS

This patent application claims the benefit of U.S. Provisional Patent Application No. 61/474,744, filed Apr. 13, 2011, and U.S. Provisional Patent Application No. 61/410,316, filed Nov. 4, 2010, which are incorporated herein by reference in their entireties.

### BACKGROUND OF THE INVENTION

Prices fluctuate. This simple and inherent feature of markets has concerned buyers and sellers throughout recorded economic history. Even participants in ancient agricultural markets understood that farmers invested early in a season without knowing whether their mature crops would yield high or low prices at the season's end. Similarly, buyers who relied on food sales could not know whether their future purchases would be costly or cheap. As a result, abundant yields leading to plummeting prices could bankrupt sellers; meager yields and soaring prices could do the same to buyers. This situation is so common that economies—and common parlance—summarizes it in a single word: “risk,” specifically, the risk of price movements.

Financial economics has also developed mechanisms for treating risk—and in particular, the risk of price movements—as a commodity, available for commercial transactions between buyers and sellers. The most basic of these mechanisms is a futures contract. One example of a futures contract is where a buyer and seller agree today that, at some fixed time (or within some fixed time window) in the future, the seller will deliver to the buyer a fixed quantity (or up to a fixed quantity) of a well-defined product at a pre-arranged place (or set of places). The buyer will pay a fixed sum of money (or a fixed per-unit price) to the seller at some agreed time and place (typically but not always either the time of signing the contract or the time of delivery).

Though references to “futures contracts” often carry specific connotations concerning formalized, uniform contracts traded on a regulated exchange, it will be appreciated that the concept of a futures contract itself is much broader. Stated simply, a “futures contract” includes all sorts of advanced sales in which a buyer and seller fix a quantity, a price, and at least one time for future performance on one or both sides. For the purposes of the present invention, all references to “futures contracts” are meant in this general sense to include both informal, nonstandardized forward sales and formal contracts traded on regulated exchanges, unless the specific context of the referent compels a narrower meaning.

Futures contracts generally shift risks between buyers and sellers. Under some circumstances, futures contracts can eliminate risk from both. For example, if the seller agrees to deliver a minimum that he is certain to possess, and the buyer consumes the purchased amount herself, the parameters of the deal are fully known ahead of time, and no one risks any harm from fluctuating prices. However, even in this example, other risks persist. In particular, buyers and sellers both risk “bad” deals. If prices fall between the time of agreement and the time of delivery, the buyer will effectively pay above (spot) market rates for the goods when received. Conversely, if prices rise, the seller will effectively accept below (spot) market rates at delivery time of delivery. Economics has developed formal and informal mechanisms for commoditizing this type of risk as well: options contracts, including both regulated and unregulated call options and put options.

One example of a call option is where, in exchange for a fixed price, a seller agrees to allow a buyer to purchase (from seller), at some fixed time (or within some fixed time window) in the future, for a fixed price (or a fixed per-unit price) a fixed quantity (or up to a fixed quantity) of a well-defined product. If the buyer chooses to exercise the option, the seller will deliver the purchased goods at a pre-arranged place (or set of places) in exchange for payment provided in a pre-arranged manner (or set of manners).

One example of a put option is where, in exchange for a fixed price, the buyer agrees to allow the seller to sell (to buyer), at some fixed time (or within some fixed time window) in the future, for a fixed price (or a fixed per-unit price) a fixed quantity (or up to a fixed quantity) of a well-defined product. If the seller chooses to exercise the option, the seller will deliver the purchased goods at a pre-arranged place (or set of places) in exchange for payment provided in a pre-arranged manner (or set of manners).

It will be appreciated that such options may be formal or informal, attached to standardized futures contracts traded on regulated exchanges, or not. Like the underlying futures contracts, options contracts shift some risks between buyers and sellers. For the most part, however, if the seller has the facility to fulfill all promises internally, and the buyer to consume all purchases internally, the exchange of options contracts increases transactional certainty.

This risk reduction runs counter to the image of futures and options in common discourse. In fact, because futures and options are the basic building blocks of (at least almost) all derivatives, the idea that they are tools for reducing risk stands in direct contrast to the many stories in the popular press—and even in the popular business press—about the inherent riskiness of derivatives markets.

There is, however, an explanation of this seeming discrepancy. For the two parties involved in the physical transfer of the good in question namely the actual producer and the actual consumer—futures, options, and (appropriately designed) derivatives simply reallocate the risk of price movements from the party less equipped to withstand the risk to the party better able to withstand it. By shifting existing risk from a relatively risk averse party to a relatively risk seeking party in exchange for a small fee (i.e., small relative to the risk shifted), these contracts effectively reduce systemic risk (or at the very least, they reduce the negative consequences of that risk).

Most participants in contemporary derivatives markets, on the other hand, are middlemen trading in pure risk, rather than actual producers or consumers. Because these middlemen insert themselves into transactions that they plan neither to open nor to close, for goods, services, or securities that they never expect to see, their investments simply buy risk from one party and sell it to another. Should some relevant event occur while they are holding the risk, they may have no recourse other than to use other assets to mitigate their losses. As a result, futures, options, and (appropriately designed) derivatives, which were developed over centuries as mechanisms for reducing risk, have earned a public reputation as risky investments.

Even in today's markets, however, there are strategic uses of these financial contracts that reduce risk; to pick just one simple example, investors holding large numbers of equity shares often consider writing covered call options as ways of reducing their effective investment. Once again, this technique reduces risk precisely because the owner of the product in question (i.e., the shareholder owning the shares) is the party trading the contract.

For a variety of reasons, some cultural and some involving the economics of transaction costs, formal futures, options, and appropriate derivatives are in use today only in a few areas of our economy—primarily those involving large-scale sales of commodities or financial instruments. Their informal counterparts arise only sporadically. Their penetration (whether formal or informal) into the daily life of consumers, and in particular into the retail sector, has been limited.

The transaction costs that have largely limited futures and derivative trading to high-ticket items are not the only impediments. Some additional impediments involve consumer economics and psychology: households, particularly during periods of price stability, often lack the cash flow to make advanced purchases of any sort desirable. Some reflect that psychology through the lens of regulatory policy: contemporary regulators consider futures, options, and derivatives inherently risky, and thus attempt to protect consumers from such risks by denying them access to these useful financial tools. Some stem from the difficulty of treating many of the products sold in our retail economy as commodities; virtually all branding, packaging, and brand-specific advertising argues against both the possibility and the desirability of commodification, at least from the perspective of vendors. Some stem from the lack of creativity and innovation that many retailers—particularly in oligopolistic industries—apply to their distribution networks.

The inventors have created the above body of information for the convenience of the reader; the foregoing is a discussion of problems discovered and/or appreciated by the inventor, and is not an attempt to review or catalog the prior art.

### BRIEF SUMMARY OF THE INVENTION

The invention is directed to a system and method for facilitating the completion of contracts for conditional or unconditional forward sales (CCUFSs) of retail goods via a CCUFS exchange, in combination with a distribution network for taking delivery on completed contracts. In one embodiment, the system comprises the CCUFS exchange, which further comprises a networked computing device for transmitting information to and receiving information from a user computing device over a network, the received information comprising user submissions input by a user into the user computing device; and at least one database for storing account information corresponding to the user, contract information corresponding to user submissions input into the exchange by users, and distribution information corresponding to delivery of the retail goods to users. The system also comprises a retail distribution network comprising a plurality of retail distribution points, wherein a retail distribution point further comprises a retail distribution point interface accessible to users for communicating with the exchange. The user submissions may be offers to sell and offers to buy, and may include type, price, quantity, place of delivery, and time of delivery terms.

Offers to sell having similar place of delivery, time of delivery, and type terms may be pooled together. If offers are pooled, the CCUFS exchange may further include an inventory rebalancing module for processing distribution-related imbalances. Facilitating transfers of retail goods and/or money from retailers corresponding to retail distribution points that under-delivered to retailers corresponding to a retail distribution points that over-delivered, wherein the amount of money transferred is based on the amount of retail goods that were under-delivered and/or the amount of retail goods that were over-delivered, allows for correction of distribution-related imbalances. In a further embodiment, purchases between retailers at a predetermined price may be facilitated by the inventory rebalancing module. The predetermined price may be an agreed price between the retailers, an external source of prices for the retail good, or a price set by the exchange based on a valuation of the retail good.

The user submissions received by the system may be input by a user through a contract writing interface, wherein the contract writing interface is based on the type of contract offer being input. Types of users may include retail consumers, retail sellers, and traders, and the retail good may be gasoline.

The invention may also be embodied as a method, comprising receiving inputs from users, at the CCUFS exchange, corresponding to CCUFS offers; storing the offers at the CCUFS exchange; filling the offers to generate filled CCUFSs, wherein the retail goods are distributed to the users at the retail distribution points based on terms of the filled CCUFSs; and receiving information at the exchange over the network from the retail distribution points corresponding to the distribution of the retail goods to the users at the retail distribution points based on terms of the filled CCUFSs. Filling the offers may further comprise one of: matching at least one existing offer with a newly received offer; matching at least two existing offers with each other; and receiving user input corresponding to the user choosing to fill an existing offer. Similarly, the offers may include type, quantity, price, place of delivery, and time of delivery terms and may be pooled, and inventory rebalancing may be performed.

It will be appreciated that, in a further embodiment, the described system and method may be implemented as computer-executable instructions stored on a tangible, non-transient computer-readable memory.

Other objects and advantages of the invention will become apparent upon reading the following detailed description and upon reference to the drawings.

### BRIEF DESCRIPTION OF THE SEVERAL VIEWS OF THE DRAWING(S)

FIG. 1 is a block diagram of an exemplary operating environment usable in embodiments of the described principles;

FIG. 2 is a flowchart generally illustrating steps occurring in a process for facilitating futures-type transactions through a computer-implemented exchange in accordance with embodiments of the described principles;

FIG. 3 is a diagram illustrating the presentation of contract writing interfaces in accordance with an embodiment of the described principles;

FIG. 4 is a diagram illustrating the presentation of a contract filling interface in accordance with an embodiment of the described principles;

FIG. 5 is a diagram illustrating the operation of an inventory balancing module within the exchange in connection with a retail distribution network in accordance with an embodiment of the described principles;

FIG. 6 is a flowchart illustrating the relationship among exemplary global data structures when a user enters a user submission into an exemplary exchange system;

FIG. 7 is a flowchart illustrating an exemplary matching process in the exemplary exchange system;

FIG. 8 is a flowchart illustrating exemplary information processing associated with the distribution of retail goods to a consumer in the exemplary exchange system; and

FIG. 9 is a flowchart illustrating an exemplary rebalancing algorithm usable in the exemplary exchange system.

### DETAILED DESCRIPTION OF THE INVENTION

Before discussing the details of the invention and the environment wherein the invention may be used, a brief overview is given to guide the reader. In general terms, not intended to limit the claims, the invention is directed to a system and method for facilitating the completion of contracts for conditional or unconditional forward sales (CCUFSs) of retail goods via a CCUFS exchange, in combination with a distribution network for taking delivery on completed contracts. The CCUFS exchange is a computer-implemented system accessible over a network (e.g. the Internet), and it will be appreciated that the term CCUFS includes futures contracts, put and call options contracts, secondary sales contracts, and any derivatives based on any combination of futures contracts, put and call options contracts, and secondary sales contracts. It will be appreciated that various implementations of a CCUFS exchange may permit trading in some or all types of CCUFSs.

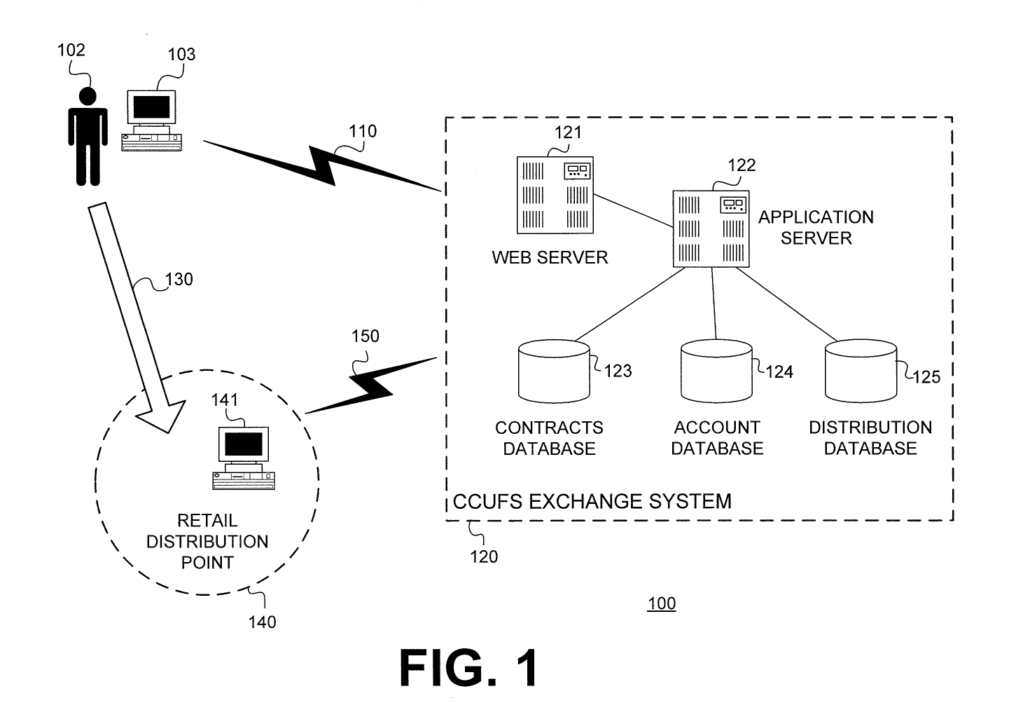

Given this overview, an exemplary environment in which the invention may operate is described hereinafter. It will be appreciated that the described environment is an example, and the components depicted do not necessarily imply any limitation regarding the use of other environments to practice the invention. With reference to FIG. 1 there is shown an example of a system 100 that may be used with the present method and system and generally includes a user 102 and a user computing device 103, a centralized CCUFS exchange 120 accessible over a network, and a retail distribution network comprising a plurality of retail distribution points 140 (only one is depicted for simplicity). The user 102 may, for example, be a retail consumer, a seller such as a supplier of retail goods, or a broker. Generally, regarding futures contracts, put options, and call options, retail consumers will submit offers to buy (e.g. bids) or select from existing offers to sell, and sellers will submit offers to sell or search for offers to buy that they can fill. Retail consumers and sellers may also submit offers to buy and sell on secondary transactions (e.g. reselling). Furthermore, traders may also utilize the centralized exchange 120 to perform more complex derivatives transactions. However, it will be appreciated that any user, whether a retail consumer, seller, or trader, may be allowed to perform any of the contract drafting and exchanging described herein.

The CCUFS exchange 120 is preferably implemented via a networked system, accessible over the Internet, and a user 102 accesses the network (110) from a user computing device 103. The user computing device 103 may, for example, be a personal computer, laptop, cell phone, PDA, table computer, or any other type of device capable of accessing the network and suitable for performing the appropriate processing. A graphical user interface may be presented to the user on the user computing device 103 through a browser or software application based on information sent over the network 110 to the user computing device 103 by the web server 121, and an application server 122 may carry out the functionality associated with the CCUFS exchange 120, including but not limited to processing user inputs received at the web server 121, accessing information from databases, filling offers to sell and offers to buy, matching existing offers to buy with existing offers to sell, tracking retail distribution information, performing rebalancing calculations, etc. The application server 122 may access a contracts database 123 for storing information related to the CCUFSs including but not limited to offers to buy, offers to sell, options, secondary sales, derivatives, and/or filled contracts; an account database 124 for storing information related to users including but not limited to account numbers or identifiers, balances or credits associated with the users, records of transactions associated with the users including but not limited to open offers to buy and offers to sell, filled orders pending delivery, past completed transactions, and past offers to buy and offers to sell that were never filled, and information regarding products available to the user such as product type, variations, and limitations and conditions; and a distribution database 125 for storing inventory information as well as information relating to retail distribution points such as product availability and transaction histories corresponding to particular retail distribution points. Although the terms “web server,” “application server,” and “database” are used herein in describing the illustrative exemplary system, it will be appreciated that the function of such computing devices may be served by other types of computing devices in alternative implementations. For example, general purpose networked computing devices may be configured to act as a web server, application server, or database with appropriate programming or software. It will further be appreciated that multiple web servers and application servers or networked computing devices may be utilized.

It will be appreciated that the CCUFS exchange 120 is preferably implemented in a secure computing environment such as through the use of secure servers, and users may be required to use at least one of an account number, password, electronic or physical access cards or keys or some combination thereof to access the CCUFS exchange 120 from their user computing devices 103 or at retail distribution points 140 through computing devices 141 located at the retail distribution points 140. Thus, for example, a consumer 102 may have to verify the consumer's identity at their user computing device 103 when filling an offer to sell, and later on when the consumer travels 130 to a retail distribution point 140 to take delivery pursuant to the filled contract, the consumer 102 may again have to verify the consumer's identity at computing device 141, which provides a retail distribution point interface to the consumer 102. It will be appreciated that the computing device 141 at the retail distribution point 140 may also be a personal computer or any other type of computing device, and may preferably be a type of kiosk or computer terminal capable of accessing the exchange 120 over the network (150).

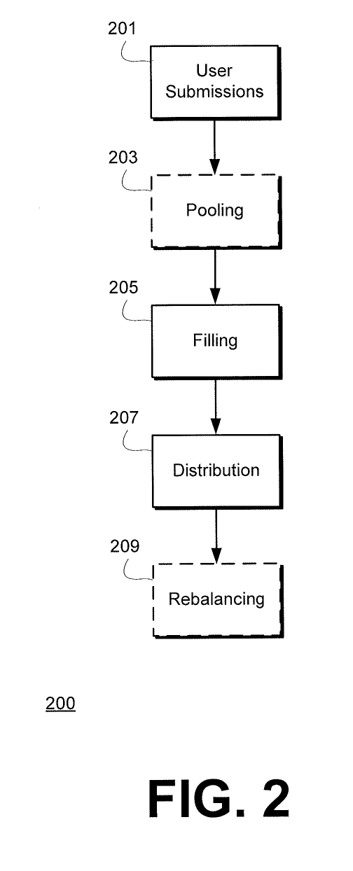

With further reference to the architecture of FIG. 1, and turning more specifically to FIG. 2, a process 200 for completing transactions according to the centralized CCUFS exchange 120 is depicted. It will be appreciated that FIG. 2 illustrates the various general components of the overall process, and the steps, with respect to different CCUFS offers, may all be occurring simultaneously and in any order. However, with respect to one exemplary transaction in particular, an offer to sell by a seller is first submitted (201). The sales offer may be pooled with other similar sales offers (203), and may be filled (205) through consumers selecting and filling the offer or through matching of the sales offer with an existing offer to buy. The consumer may later take delivery on the completed futures contract, and the product corresponding to the filled offer is distributed to the consumer (207). After the window for receiving delivery of retail goods within a pool has expired (or after all retail goods in the pool have been distributed), inventory rebalancing (209) may occur between sellers to account for over-distribution and under-distribution at particular retail distribution points. It will be appreciated that pooling (203) and inventory rebalancing (209) are highly advantageous for commercial implementations of the described invention but are not required to implement a working CCUFS exchange 120 as described herein. It will further be appreciated that this process also applies to other exemplary transactions based on other types of user submissions, such as offers to buy, put or call option offers, secondary sales offers, and derivatives offers. Each step depicted in FIG. 2 will be described in detail further below.

It will be appreciated that other types of general environments may be used, such as a cloud computing configuration, or implementing more functionality through local software at a user computer device 103 rather than at the centralized CCUFS exchange 120. For example, the environment may be configured such that the user enters information into a browser or software application at user computing device 103 and processing of that information (e.g. pooling and matching) takes place at the application server 122, or the environment may be configured such that the application server 122 merely provides access to the relevant databases and the processing of information retrieved from the databases takes place utilizing software applications at the user computing device 103 instead. Additionally, it will be appreciated that three different databases are depicted for illustration purposes only and that in practice, a single database (or any other number of databases) may be used to store the information stored by the three databases described herein.

It will further be appreciated by those of skill in the art that the execution of the various machine-implemented processes and steps described herein may occur via the computerized execution of computer-executable instructions stored on one or more tangible, non-transient computer-readable media, e.g., RAM, ROM, PROM, volatile, nonvolatile, or other electronic memory mechanism. Thus, for example, the operations performed by the user computing devices 103 and computing device 141 at a retail distribution point 140 may be carried out according to stored instructions or applications installed at the user computing devices, and operations performed at the CCUFS exchange 120 may be carried out according to stored instructions or applications installed at the exchange.

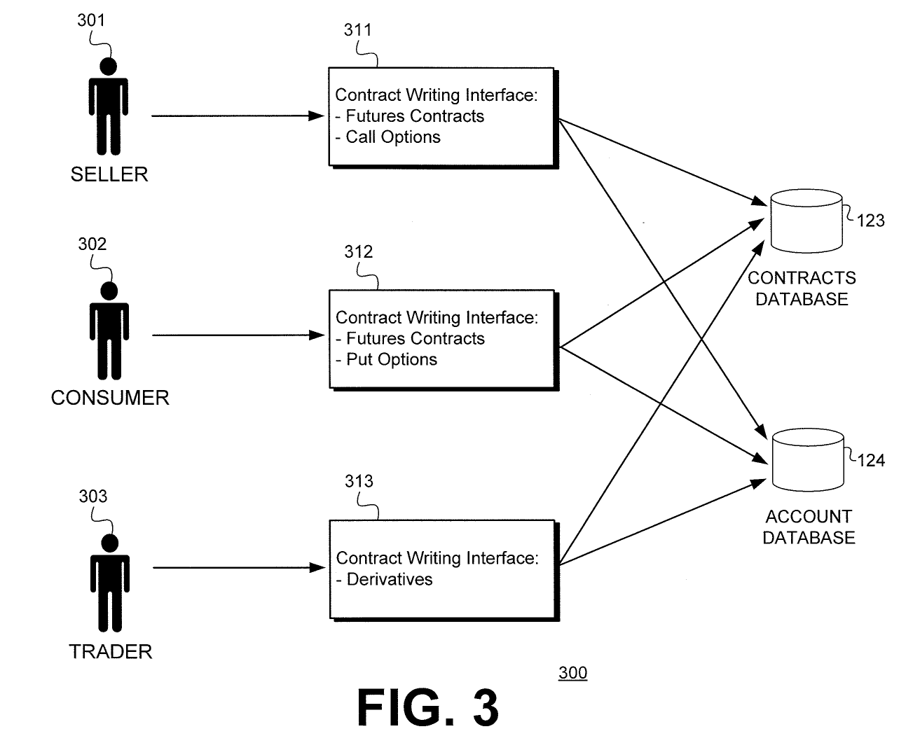

With further reference to the architecture of FIG. 1 and the overall process of FIG. 2, and turning more specifically to FIG. 3, a diagram 300 illustrating the entry of user submissions into the CCUFS exchange 120 is depicted. Different contract writing interfaces may be presented to the user at the user's computing device 103 (whether through a browser or through some other application) based on input by the user within the graphical user interface associated with the CCUFS exchange 120 allowing the user to navigate to the different contract writing interfaces. In a further embodiment, based on an identification of the user as a seller, consumer, or trader, the user may be directed to certain contract interfaces appropriate to the user. For example, a seller 301 may log-in or otherwise access the system in a manner that identifies the seller (e.g. including but not limited to one of the manners described above such as with an access card or key), and the seller 301 be presented with contract writing interfaces for drafting offers to sell on futures contracts or for drafting call option offers. Similarly, a buyer may access the system and be presented with contract writing interfaces for drafting offers to buy on futures contracts or for drafting put option offers (or secondary sales offers), and a trader may access the system and be presented with contract writing interfaces for drafting relatively complex derivatives offerings.

It will be appreciated that in one embodiment, any contract writing interface may be made available to any type of user, and the user may simply navigate a graphical user interface by selecting appropriate links or buttons to reach a desired contract writing interface. In a further embodiment, the types of contract writing interfaces available to the user may depend on the type of user, which may be stored in the account database 124. Thus, when a consumer 302 accesses the system, the only contract writing interface options accessible to the consumer may be to draft offers to buy on futures contracts or draft put option offers (or secondary sales offers).

Both long and short futures sales offers and put and call options may be drafted by sellers, consumers, and/or traders. It may be preferable to only allow sellers such as retailers operating from long position or those in comparable possession of long position and retail delivery capabilities to originate long sales offers on futures contracts and call options to ensure that the drafter will be capable of future delivery. The basic terms of a sales offer, whether by a seller from a long or short position, may include but are not limited to the product description, quantity, place or places for delivery, time of delivery, and price. For an offer to sell a call option, the basic terms may include product description, quantity, place or places for delivery, time of delivery, and price, as well as a strike price at which a buyer can exercise the option to purchase or to sell either a futures contract or retail delivery of the product according to those basic terms, and an indication of ranges of times and/or places that the buyer may exercise the option, which may be defined by specific temporal and geographic points or boundaries. It will be appreciated that the time and/or place of exercise of a call option may or may not be the same as the time and/or place of delivery.

Further details of the basic terms of an exemplary offer to sell (for a futures contract) are given below.
Type: may include any specifications regarding the product necessary to disambiguate the product among various products offered for sale within a category of retail products; may include a description of whether the quoted price includes some, all, or none of the taxes that may be applicable at either the point of contracting or at the point of retail delivery; may include a description of other services, products, or auxiliary sales that may be applicable at either the point of contracting or at the point of retail delivery.
Quantity: may include a number of units and/or indications as to whether the consumer taking retail delivery must accept the full amount at once, may split the delivery, may forfeit any amount not received in the original delivery or after some maximum number of partial deliveries, or may be required to pay for delivery and/or disposal of the product at some fixed time and place whether or not the consumer still desires the product at that point.
Place(s) of Delivery: may include a geographic region such as a county, state, or collection of counties or states; a specific retail outlet or collection of identifiable retail outlets, such as but not necessarily those bearing the signs of one or several company brands, or those displaying any other sort of identifiable logo or symbol that allows them to be identified as an outlet where delivery may be performed.
Time of Delivery: may include a range of time such as minutes or days or months throughout which a retail customer may demand and/or receive delivery; may begin immediately after the purchase of the contract or at a later point in time.
Price: may be specified in per unit terms and/or as a total for the entire contract; may include fees, commissions, taxes, or other transaction costs applicable to either buyer or seller upon filling the offer; may specify whether payment is due upon filling the offer, upon a certain date such as the beginning of the time of delivery, upon receipt of delivery or first delivery, or at some other time.
   It will be appreciated that the details included within these descriptions of the various terms are intended to illustrate a particular example and are not mandatory. Various embodiments of the invention may include more or less detail than described above.

Table I presents an example of information fields that may be associated with an offer to sell (for a futures contract). It will be appreciated that some of the items of information such as Writer ID may be filled automatically based on the account information of the user accessing the system, some items such as a “contract ID” may be supplied by the system automatically, some items such as type, quantity and price may be input by the user, and other items may be supplied by the user or the system, and may be updated automatically by the system based on certain events (e.g. “current owner” of the contract being updated as the contract is exchanged). It will further be appreciated that the items of information associated with various contracts are not limited to those recited in exemplary Tables I.

TABLE I
Offer to Sell a Futures Contract

| | |
|---|---|
| Writer ID: | an ID or designation of original inventory source |
| Contract ID: | a unique number identifying the offer or |
| | contracts arising from the offer |
| Current Owner: | an identification of the current owner of the offer or |
| | contracts arising from the offer |
| Type: | description of product and/or product type and may |
| | include restrictions on product |
| Quantity: | indication of quantity of product for sale |
| Place of Delivery | may include limitations on place of delivery and/or |
| | designation(s) of eligible retail distribution points |
| Time of Delivery | indication of available time for delivery |
| Price of Contract | indication of cost to buyer |

With respect to an offer to sell a call option, an entry in the database may include all of the information items from Table I, wherein the price of the contract is the price of the option contract, and additionally include the exemplary information items shown by Table II.

TABLE II
Offer to Sell a Call Option

| | |
|---|---|
| Strike Price: | cost at which buyer may purchase retail goods if the |
| | option contract is exercised |
| Time of Exercise: | limitations on time at which the option may be exercised |
| Place of Exercise: | limitations on place at which the option may be exercised |

It will be appreciated that the principles of contract writing illustrated by Tables I and II apply to both offers to sell and offers to buy, and to put options as well as to call options. Additionally, it will further be appreciated that one skilled in the art could easily modify the exemplary contract writing interfaces for selling futures contracts and call options to generate similar contract writing interfaces for drafting offers to buy futures contracts and to sell put options.

As depicted by FIG. 3, traders may also access the exchange and be presented with a contract writing interface for more complex transactions and/or derivatives, such as a straddle combining the purchase of put and call options for a fixed product and time into a single transaction, or the simultaneous purchase of a futures contract and sale of a covered call option. Thus, a more flexible and open-ended contract writing interface may be presented to allow traders (or any other party) to write complex derivatives based on combined aspects of futures and options contracts as described above, or write secondary sales-type contracts for derivatives, futures, and options contracts. It will be appreciated that, as derivatives contracts may include virtually any combination of offers to sell, offers to buy, put options, call options, and secondary sales offers, the contract writing interface for more complex transactions may allow the user 303 to input terms into a blank template, or to generate customized fields and parameters.

Regardless of which type of contract is submitted by the user, these contracts may be stored into a contracts database 123 as described above. The contracts database 123 may be used to store “active” contracts (e.g. offers to sell and offers to buy waiting to be filled and filled contracts waiting to be distributed) as well as contracts that are no longer active (e.g. expired offers to sell and offers to buy that went unfilled and contracts for which distribution has already occurred). As described above, each contract may contain certain user information such as an identification of the user that drafted the contract and an identification of the user that currently owns the contract. Furthermore, records of “active” and “inactive” contracts may be associated with various users in the account database 124 (e.g. whether in their entireties or by identifiers corresponding to the contracts in the contracts database) in addition to the user information stored at the account database 124.

Given a large number of sales offers including unambiguous definitions of parameters including but not limited to product type, delivery time, delivery place, or other limitations and conditions, a virtual “pool” of products having shared parameters may be formed, as referred to in FIG. 2 as “pooling” (203). For example, separate offers to sell specifying the same product, having a same delivery time within the same range, and available for distribution at a same set of retail outlets may be designated as part of the same pool. Thus, the exchange 120 may compare existing offers to sell and newly input sales offers to determine whether they may be pooled, and if so, incorporate them into various pools, allowing consumers holding a contract originating from any seller participating in the pool to take delivery from any seller participating in the pool. This is advantageous as it allows, for example, a consumer who filled a sales offer drafted by one seller to take delivery from a different seller so long as both sellers are participating in the same pool of which the sales offer is a part. Furthermore, participants in a secondary market in which a pool operates may similarly treat all inventories fed into the virtual pool upon closure of a contract as fungible commodities.

It will be appreciated that pooling is not a requirement for the exchange 120 to operate, but is a preferable feature as it is highly advantageous in any commercial implementation of the described exchange system, particularly when implemented along with a corresponding inventory rebalancing module as described in further detail below. It will further be appreciated that secondary sales contracts may similarly be pooled (with other secondary sales offers as well as with ordinary offers to sell).

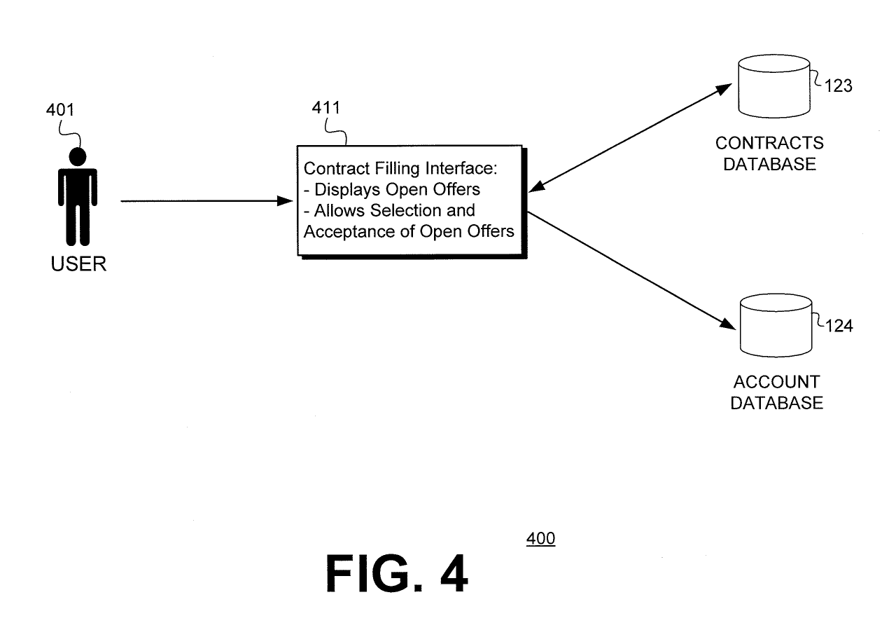

With further reference to the architecture of FIG. 1 and the overall process of FIG. 2, and turning more specifically to FIG. 4, a diagram 400 illustrating the filling 205 of existing offers to sell and offers to buy in the exchange 120 is depicted. A user 401 accesses the exchange 120 through a user computing device, and the user may navigate the graphical user interface to search for open offers to sell, offers to buy, put and call options, and other types of open offers. For example, if the user 401 is a retail consumer, the user may be presented with an interface displaying unfilled offers to sell entered into the contracts database 123 by retail sellers along with the terms of those offers. The user 401 may then search the contracts database 123 or filter the offers displayed to the user 401 using one or more criteria, such as product type, quantity, price, place of delivery, or time of delivery.

If the user 401 finds an open offer to sell that the user 401 wishes to accept, the user may select the offer to sell and fill it, either partially or completely. For example, if the open offer is for x quantity of retail goods, the user 401 may indicate that the user wishes to purchase y quantity, where y is less than x, and thus a contract for y goods will be filled and may be stored in the contracts database 123 (and the account database 124 may be updated accordingly), and the open offer to sell x quantity of goods may be changed to an open offer to sell for (x-y) quantity of goods. This update of the quantity would preferably be automatically implemented by the exchange. It will be appreciated that a similar method of accepting open offers can be applied to other types of users and other types of contracts, including retail sellers and traders and open offers to buy, put and call options, and derivatives and secondary sales. It will further be appreciated that offers to sell originating from different retail sellers that are part of a “pool” may be presented to the user as a single offer with the quantities of the individual offers of the pool aggregated into one cumulative quantity. Moreover, if the aggregated offers had been originated with different price terms, the system may quote any price or any combination of prices less than or equal to a price specified by a user, if possible (and may further indicate the quantity available at each price). The system may also quote quantities available at higher prices for informational purposes to allow the user to raise the proffered price.

In a further embodiment, the CCUFS exchange may match existing offers to buy with existing offers to sell (as well as existing offers to sell options with existing offers to buy options, etc.). This matching may be performed automatically when a contract offer is entered into the contracts database that matches up with an existing contract offer, may be performed automatically on a periodic basis, may he performed in response to a system operator's command, or according to other manners of scheduling. For example, if a retail consumer inputs an offer to buy specifying a certain quantity, price, place of delivery, and product, and a seller subsequently inputs a matching offer to sell, specifying a corresponding price, place of delivery, and product, the system may match the two offers and generate a single filled contract. It will be appreciated that this matching process may be applied to any types of contracts, and it will further be appreciated that the quantity terms may differ (e.g. with the offer to sell or offer to buy having the larger quantity term being only partially filled). Furthermore, it will be appreciated that an offer may be matched with more than one existing offers. For example, if multiple offers to sell are filled up to the point where only a few gallons remain, and a consumer enters in an offer to buy a large number of gallons, the CCUFS exchange may match the offer to buy with multiple offers to sell, fulfilling the offer to buy by taking gallons from multiple existing offers to sell.

In a further embodiment, two offers may be matched even if the price terms of the two offers differ, assuming that the offer for sale has a price that is lower than the offer to buy. This may occur if a seller inputs a sales offer for a futures contract into the system at a relatively low price, and a consumer inputs an offer to buy for a futures contract with the same time and place of delivery terms at a relatively higher price. The CCUFS exchange may nonetheless match the two offers, and it will be appreciated that the difference between the two offers may be handled in a variety of ways because such a situation creates an arbitrage opportunity. For example, the buyer and the seller may split the difference so that each receives some compensation, or rebates may be awarded to buyers or sellers, or the difference may be collected by the exchange, etc. It will thus be appreciated that in different embodiments, different divisions of the arbitrage opportunities among consumers, retailers, and exchange profits are possible.

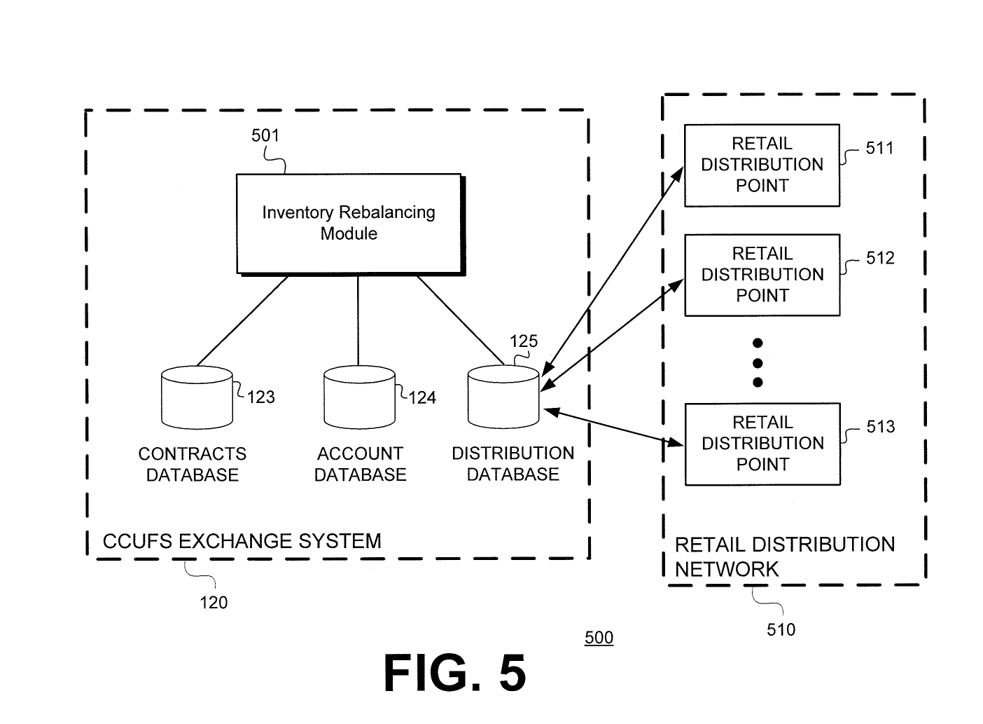

With further reference to the architecture of FIG. 1 and the overall process of FIG. 2, and turning more specifically to FIG. 5, a diagram 500 is depicted illustrating the operation of the inventory rebalancing feature 209 of the CCUFS exchange 120 in connection with a corresponding retail distribution network 510. As described above with respect to FIG. 1, a retail consumer 102 may take delivery of a retail good to which the consumer 102 owns a filled contract according to the terms of the contract. Depending on the limitations on the place of delivery specified by the contract, the consumer 102 may take delivery at one or more of a plurality of retail distribution points 140 (e.g., any retail distribution point corresponding to a retailer participating in the pool that the contract is a part of). At an appropriate retail distribution point 140, the consumer 102 may identify himself or herself at a retail distribution point interface 141 by logging in, presenting an access card, a key, or through other means. The consumer 140 may then take delivery of the previously contracted—for retail goods. It will be appreciated that though the consumer incurred the obligation for payment for the delivered goods at the time of contracting, the consumer may also incur additional obligations for payment of taxes or auxiliary services, as specified in the terms of the underlying contract, at the time of physical delivery. The consumer's actual payment of either or both obligations may occur at the retail distribution point, may occur in advance of delivery, may occur after delivery, or some combination thereof, and it will further be appreciated that payment may comprise deducting credits associated with the user's account or conventional methods of payment (such as paying by cash or credit card at the retail distribution point, or paying by credit card online). Additionally, it will further be appreciated that the consumer may take partial delivery or full delivery upon a contract, and that contracts may specify in their terms whether partial delivery is permissible or if full delivery is required, as well as specifying the manner of payment.

The retail distribution point interfaces 141 at the various retail distribution points 511, 512, 513 communicate with the CCUFS exchange 120 and access the distribution database 125 to determine whether a requested delivery is available at that retail distribution point and to keep track of distributed retail goods. For example, when a consumer requests delivery at a retail distribution point, the interface device may first check with the exchange system to determine whether the retail good requested is available to be delivered to that consumer at that time and place (e.g. whether the retail distribution point corresponds to a retailer that is a participant of the pool associated with the requested retail good and whether the product is eligible for delivery at that time), and if so, it may record the distribution in the database after the retail good has been delivered. The account database 124 and contracts database 123 may also be updated accordingly (e.g., fully delivered contracts may be designated as such within the contracts database 123 and distribution events may be recorded with a user's account information in the account database 124). In the context of options contracts, the retail distribution point interfaces 141 may further check to determine whether certain preconditions have been met, such as the exercise of the option and payment of the strike price.

An inventory rebalancing module 501 within the exchange system 120, preferably implemented in software (although it may be implemented in firmware or hardware as well), may be utilized to perform inventory rebalancing after the conclusion of the distribution of items within a pool (e.g. by completing distribution of all items or expiration of the specified time for delivery). Because pooling retail goods may result in certain imbalances due to under-delivery or over-delivery by some retailers or locations participating in the pool (i.e., retail delivery of smaller or larger quantities than contracted for by particular retail sellers), as well as by consumers failing to take delivery on some or all of their completed contracts, a rebalancing algorithm with predetermined rules should be applied by the system to account for these imbalances. This rebalancing algorithm may be carried out by an inventory rebalancing module 501 within the CCUFS exchange system 120 that accesses the distribution database 125. An example of a rebalancing algorithm is given in the exemplary system described below.

In a further embodiment, the inventory rebalancing module 501 of the CCUFS exchange system 120 may also serve as a market maker by purchasing inventory from one retailer (e.g. extra inventory from a retail outlet that under-delivered) and reselling it to a second retailer (e.g. a retail outlet that over-delivered) at a predetermined price that may be set by the system (for example, the price could be set based on information in the contracts database indicative of the current value of the retail good), specified by the retailers, or based on an external source such as a government-published price index. In yet another further embodiment, these “rebalancing” type transactions may be performed by retailers regardless of whether the transactions are needed to rebalance distribution imbalances.

An exemplary embodiment of the system will be described in the context of a CCUFS exchange for CCUFSs relating to the retail sale of gasoline, a widely traded good that consumers typically treat as a commodity whether or not it fulfills all of the technical economic conditions that formally define a “commodity.” Retail sales of gasoline are distinct from, and made in much smaller quantities than, the various oil, fuel, and energy contracts currently traded on established commodity exchanges. Additionally, gasoline is already distributed through a large retail distribution network (i.e., gas stations) with networked devices measuring and monitoring distribution and communicating with payment systems (i.e., gas pumps with automated displays linked to credit and debit systems), and is subject to significant price swings, making it highly suitable for the CCUFS exchange system described herein. It will be appreciated that, for the sake of simplicity and ease of description, this exemplary system does not include all possible features or variations on the inventive principles contemplated herein, and is intended only to demonstrate the basic operation of the inventive system and method in an exemplary embodiment. It will also be appreciated that, whether or not retail gasoline meets all technical definitions to qualify as a commodity, most consumers treat retail gasoline as if it were a commodity. The exemplary embodiment similarly treats retail gasoline as a commodity.

As described above, this exemplary embodiment includes a centralized CCUFS exchange accessible to users and retail distribution points over a network through which CCUFSs may be input and filled, a distribution network including participating retail outlets (i.e. participating gas stations operated by participating retailers), and an inventory rebalancing module within the CCUFS exchange for facilitating rebalancing transactions between the participating retailers. The system is implemented in the form of computer-executable instructions on tangible, non-transient computer-readable media at appropriate locations, such as centralized servers for the CCUFS exchange and at retail distribution point interfaces for the various retail outlets. The system may further optionally be implemented on computer-readable media on user computing devices, such as personal computers and mobile devices.

In the example described herein, the code was written on an Apple Macintosh running OS X using an Eclipse Helios 3.6.2 IDE for Java SE 6, and designed to output data in a Microsoft Excel-compatible format (.xls) using JExcelAPI. The output .xls file is used as a presentation aid for verifying the effective operation of the system in this exemplary embodiment. It will be appreciated that the exemplary embodiment was set up to demonstrate and verify the operability of the present invention, and that other programming languages, data formats, and methods of data storage may be utilized in commercial embodiments of the described invention.

For simplicity, the following assumptions and restrictions were utilized in designing this exemplary embodiment, but it will be appreciated that these assumptions are not intended to be limitations and are not required for the invention to work:
Only primary-market sales of futures contracts are demonstrated. Trading of options, a secondary market for secondary sales and derivatives are not demonstrated.
The system is limited to four types of gasoline products: Regular, Midgrade, Premium, and Diesel. Jurisdictional variations concerning additives, formulations, or seasonality are not considered.
Place of delivery is divided by state, and all participating retailers in a state are assumed to participate in delivery of all four product types.
Delivery time is specified by a particular month.
Retailers are assumed to make large lots (i.e., many gallons) available with a single offer, and to hold those offers open for partial fills until the entire large-lot offer is either filled fully, withdrawn, or expires.
Consumers are assumed to make offers to buy (i.e. bid) on relatively small lots (i.e., on par with their expected consumption for the month), and consumer offers to buy are entered on a “fill-or-kill” basis, meaning that those that the system cannot fill immediately are presumed canceled, and are not retained for later consideration.
All retailer offers to sell are filled at the specified asking price and all consumer offers to buy at the specified bid price, thereby creating an opportunity for arbitrage. The system tracks arbitrage opportunities, but does not specify what happens to them.
All prices mentioned anywhere in the system are for the product alone, excluding service charges and/or taxes.
Sales offers are pooled into “virtual pools” defined by a <Product, State, Month> triple. All contracts specifying the same triple are designated as belonging to the same pool, and thus receive treatment as fungible commodities.
Futures sales offers are available for purchase until the start of the month designated for delivery. Consumers may then take delivery during the designated month, but are not required to do so and may leave the order undelivered.
A commission of 1% per side per transaction is included in the front-end market (i.e., the on-line trading). The exemplary system does not include any commissions or charges for delivery. This mechanism for generating revenue is not discussed in the general description of the invention, but it will be appreciated that one skilled in the art would be able to implement a variety of methods for collecting profits, whether in the form of commissions or otherwise, in commercial embodiments of the exchange system.
Inventories are rebalanced by allowing each retailer to retain possession of the amount (of gasoline) that it sold in the futures market into each pool minus the amount delivered to consumer, if positive (i.e., the amount “underpumped”), and by compensating each retailer for that difference if negative (i.e., the amount “overpumped”).
The price for compensating retailers while rebalancing inventories is specified externally (e.g., using a government published average for the pool in question).

The exemplary embodiment utilizes four global data structures: one sorted global list each of Transaction Records (TR List) and Pool Records (PR List) and two global lists of User Records (UR), one each for retailers and consumer (URR List and URC List, respectively).

Each TR contains ten (10) information attributes:
Transaction ID is generated by the system, and serves as the sort key for the global TR List. These unique identifiers incorporate information about pricing and timing to ensure that orders are matched in the appropriate sequence.
Originator is input by the user. It identifies the retailer or consumer initiating the transaction.
Ask/Bid is a function of the originator. By assumption, all users are either retailers who originate “Asks” or consumers who originate “Bids.” This field serves as a flag for purposes of categorizing and matching this proposed transaction against others already in the global transaction list.
Pool is input by the user, as a combination of Product, State, and Month.
Open Volume is input by the user to specify the number of gallons either offered for sale (if a retailer) or desired for purchase (if a consumer).
Price is input by the user to specify the price either asked (if a retailer) or bid (if a consumer). Recall that prices in this embodiment exclude taxes and commissions.
Closed Volume is calculated internally during the transaction matching process. It tracks the number of gallons for which the transaction has closed (i.e., if the originator is a retailer, a buyer has been found; if the originator is a consumer, a seller has been found). Note that when a transaction is first entered, Closed Volume is always zero. At any time, the sum of the Open Volume and the Closed Volume for a given transaction always equals the initial Open Volume for that transaction.
Principal, Commission, and Arbitrage are calculated internally during the transaction matching process. When an Ask transaction and a Bid transaction match, the seller releases the specified number of gallons into the virtual pool in exchange for payment from the buyer. These fields track the amount paid for principal, the amount charged for commissions, and the amount available to the system by way of arbitrage, respectively.
   An exemplary UML specification of a TR is given by Table III.

TABLE III
Transaction Record
TransactionRecord

− Transcation ID : String
+ Ask/Bid : String
+ Originator : String
+ Pool : String
+ Open Volume : int
+ Closed Volume : int
+ Price : float
+ Principal : float
+ Comms : float
+ Arbitrage : float
+ TransactionRecord( )
+ initialize TRlist( ) : void
+ specialty Offer( ) : TransactionRecord

Each PR contains eleven (11) basic information attributes and two (2) informational lists:
Pool ID is the <Product, State, Month> triple that identifies the pool.
Ask Volume is the sum of Open Volume entries for all retailer-originated TRs for this pool.
Bid Volume is the sum of Open Volume entries for all consumer-originated TRs for this pool.
MinAsk and MaxBid, respectively, report the minimum asking price and maximum bid price for any offers currently open on the given pool.
Sold Volume is the sum of Closed Volume entries for all TRs for this pool. This total volume sold represents the total amount of gasoline available to date for delivery from this virtual pool. When trading on the pool closes and the pool becomes “active” and available for retail delivery, Sold Volume is locked in place.
Commissions and Arbitrage sum the commissions and arbitrage calculated for all TRs involving the given pool.
Pump Volume is the amount of gasoline delivered from this pool. It is zero until the pool becomes active and consumers begin to take delivery at points of retail distribution.
UnderPump Volume and OverPump Volume are calculated for each retailer, for each pool, and then summed for entry in the PR. At the individual level, they represent the amount that the given retailer delivered below or above (respectively) the amount that that retailer sold into that pool. Note that underpumping and overpumping are tracked separately because the inventory rebalancing algorithm need not treat them symmetrically.
AskList and BidList are the two informational lists associated with each pool. They are the lists of TRs specifying the given pool, divided into those originated by retailers (the Asks) and those originated by consumers (the Bids). Note that they are both subsets of the global TR List.
   An exemplary UML specification of a PR is given by Table IV below.

TABLE IV
Pool Record
PoolRecord

+ Pool ID : String
+ Ask Volume: int
+ Bid Volume : int
+ Sold Vol ume : int
+ Pump Volume: int
+ Underpump Volume : int
+ Overpump Volume: int
+ MinAsk : float
+ MaxBid : float
+ Commission : float
+ Arbitrage : float
+ PoolRecord( )
+ buildPoolNameList( ) : String[ ]
+ initializePList( ) : void
+ updatePool(inPool : PoolRecord, inTR : TransactionRecord) : void

Each UR contains four (4) basic information attributes and two (2) informational lists:
User ID identifies the user, both with a specific ID and as either a retailer or a consumer.
Pool Count counts the number of pools into which this user sold (if a retailer) or from which this user bought (if a consumer).
Principal and Commissions sum the principal and commission amounts, respectively, across all TRs in which this user operated (whether as the originator or as a partial or entire closer).
User/Transaction List, the first informational list, is the list of all transactions that this user originated.
User/Pool List is a list of User/Pool Records (UPR), tracking information relevant to this user's participation in each relevant pool. UPRs are an important internal data structure shown in detail in FIG. 11.
   An exemplary UML specification of a UR is given by Table V below.

TABLE V
User Record
UserRecord

+ User ID : String
+ Principal : float
+ Comms : float
+ Pool Count : int
+ UserRecord( )
+ initializeUserLists( ) : void
− initUListsTInfo( ) : void
− initUListsPInfo(AskBid : String) : void
+ updateUser(transRec : TransactionRecord) : void

Each UPR contains eight (8) basic information attributes:
User ID and Pool ID identify the user and the pool, respectively.
Contract Dollars tracks the total dollars.
Open Gallons tracks the volume that this user has on offer (to buy or to sell) in this pool.
Closed Gallons tracks the volume that this user has already sold or bought in this pool. This number is locked when trading ends and the pool becomes active.
Live Gallons starts at the locked in number of closed gallons as the pool goes live. Its primary importance is as a tracking mechanism for the amount that a consumer is entitled to pump under contract.
Pumped Gallons starts at zero when the pool becomes active, and tracks the amount given or received as retail deliveries. Its primary importance is as a tracking mechanism for the amount that a retailer pumped under the contract.
Compensation Gallons calculates the volume for which a retailer owes or is owed compensation as part of the inventory rebalancing algorithm.
   An exemplary UML specification of a UPR is given by Table VI below.

TABLE VI
User/Pool Record
UPRecord

+ User ID : String
+ Pool ID : String
+ Contract Dollars : float
+ Open Gallons : int
+ Closed Gallons : int
+ Live Gallons : int
+ Pumped Gallons : int
+ Compensation Gallons : double
+ UPRecord( )
+ extractUPUserMap(uID : String, trMap :
SortedMap<String,TransactionRecord>) : SortedMap<String,UPRecord>
+ extractUPPoolMap(pID : String, trMap :
SortedMap<String,TransactionRecord>) : SortedMap<String,UPRecord>

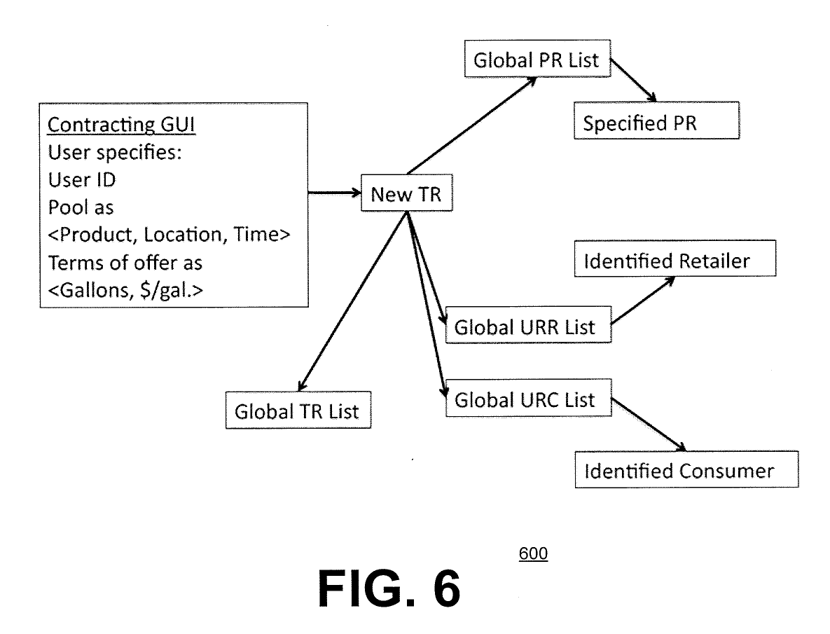

FIG. 6 depicts a flowchart 600 illustrating the relationship among these global data structures when a user enters new data into the system (i.e., in the form of an offer to either buy or sell gasoline for future delivery). As FIG. 6 shows, a user accesses a Contract Writing Interface (CWI), and specifies: (i) a user ID; (ii) a pool (by specifying product, location and time terms); and (iii) the quantity and price terms of an offer. The exemplary embodiment includes executable computer code for several testing routines capable of generating sizable volumes of data (selected randomly from plausible ranges) to supplant manual entry of offers to buy and sell using the CWI.

The system uses this information received from the CWI (or the data generation routines) to build a new TR, which it then adds to the global TR List. The system next accesses the global Pool List (PR List), finds the PR corresponding to the specified pool, and updates its information accordingly. The system next accesses the appropriate global User List (URR or URC), and either finds the corresponding UR (Identified Retailer or Identified Consumer) to update its data or creates a new UR to house the input data.

Thus, it will be appreciated that in the context of the general description given above, the CWI implements variants of the contract writing and contract buying interfaces, the PR List implements a variant of the contract database, and the UR Lists implement variants of the account database. The global TR List serves primarily as an internal processing component that ties the other databases to user input and to each other.

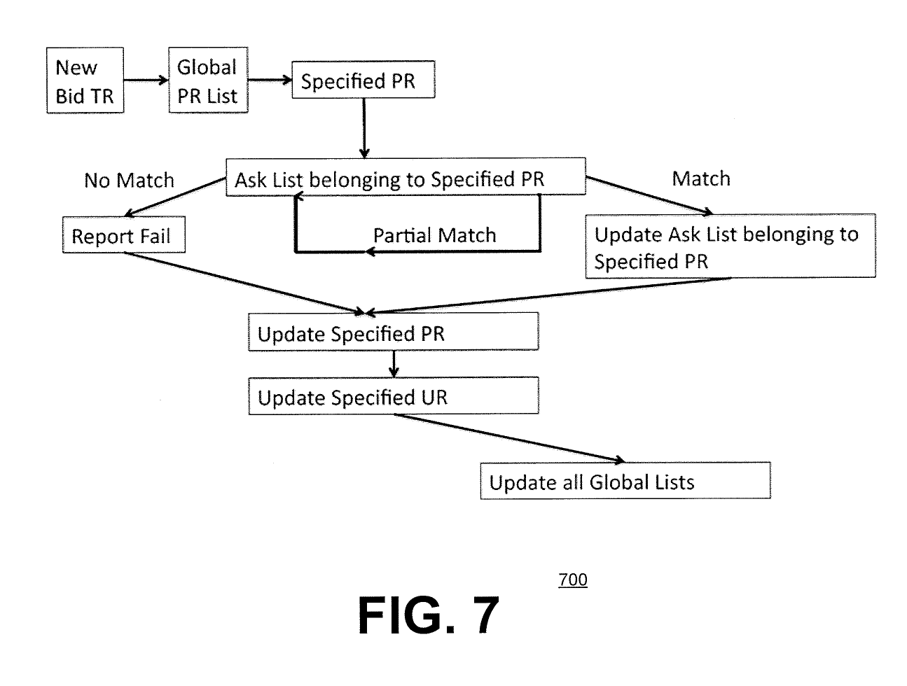

The exemplary system also illustrates the matching of open sales offers with open offers to buy after the offer to buy is entered into the system. Assuming that the TR List contains a plurality of open sales offers, a user may input an offer to buy into the system and the system may attempt to match the new offer to buy against the existing open sales offer. This exemplary matching process is depicted by FIG. 7 and includes the following steps:
1. Look at the new Bid TR to identify pool information.
2. Access the global PR List and specify an appropriate PR corresponding to the Bid TR.
3. Traverse the extracted PR's Ask List (i.e., its informational list of retailer-originated Ask TRs) sequentially, in ascending order of asking price while considering the asking price and available volume:
   a. If the Bid cannot be filled, report that a deal is impossible (No Match).
   b. If the Bid can be partially filled, record the partial fill and move on to the next TR in the Ask List (Partial Match).
   c. If the Bid can be filled (Match):
      i. Close the deal by updating the information in the new Bid TR and all TRs traversed in the Ask List.
      ii. Update the information in the URR for all retailers whose Asks were traversed.
4. Update the information in the PR.
5. Update the information in the URC for the consumer who originated the Bid.
6. Update all of the global lists and variables.

One skilled in the art will appreciate that this sequence is based on the decision mentioned above to demonstrate the interplay between standing retailer sales offers of large lots and “fill or kill” consumer bids on smaller lots. One skilled in the art will further appreciate the construction of directly analogous patterns to capture the interplay among other types of offers not demonstrated in this exemplary system.

This process of transaction matching continues as long as trading is available for the pool. Trading closes when the pool becomes available for distribution (or at some other specified time). At that point, user and pool records convert closed volumes into “live” volumes. Consumers may then begin taking retail delivery of “live” volumes. In practice, delivery will occur when a consumer holding a filled contract drives into a participating gas station. The consumer will drive up to the gas pump and enter payment information (e.g. credit or debit card account information, as many motorists currently do). The account in use, however, will link to the exchange system (likely in addition to a payment system). The pump might enumerate all deliveries available from that outlet at that time, for which the motorist had prepaid under this contract, along with further amounts due to accommodate all taxes then and there applicable. The motorist will then specify which gallons, pursuant to which contracts and/or spot purchases (i.e., purchases at the posted price at the point of retail distribution), are desired for delivery, and take delivery, making whatever additional payments were necessary. The exchange system updates the amount(s) available under each contract then in the motorist's account following the delivery. The exemplary embodiment simulated retail distribution for verification and presentation purposes.

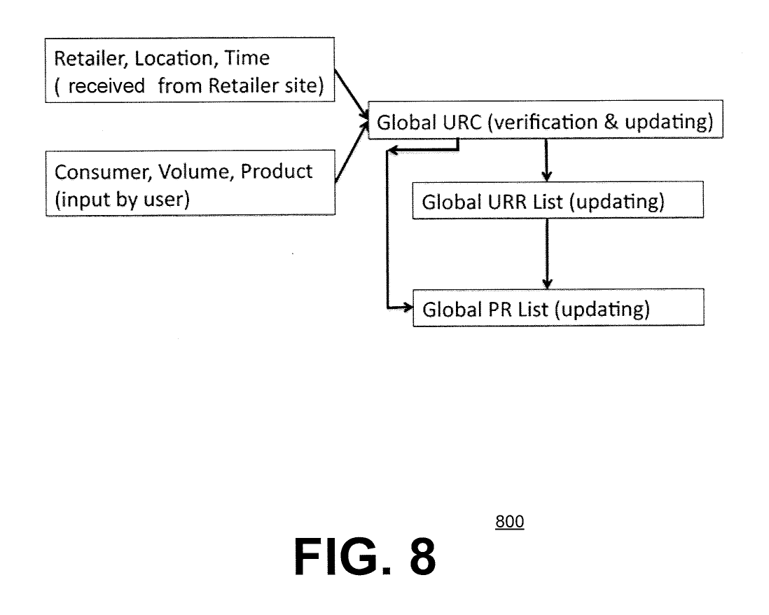

This flow of information associated with the distribution of gasoline to the consumer is shown in FIG. 8. When a consumer arrives at a gas station and accesses the exchange system through a retail distribution point interface, the following steps will occur:
1. Known information about the state and month are sent to the exchange by the point of retail delivery over a network.
2. The consumer enters an ID, a specific product, and a volume desired.
3. The system verifies that the consumer owns the specified number of gallons in the specified pool. (The system may also allow the consumer to augment contract purchases with purchases on the spot market at posted prices).
4. The system calculates net costs due from taxes, auxiliary services, spot purchases, or other items purchased concurrent with the delivery of the pre-purchased volume.
5. The system updates the consumer and retailer URs within the exchange with the amount pumped.
6. The system updates the PR within the exchange with the information from this delivery.

This delivery process may continue and be repeated for a particular pool until the month ends or until all contracts in the pool have been distributed. At the end of a month, it is likely that some consumers will have forfeited unclaimed volume (as a technicality, consumers are likely to agree by contract to “sell” that volume back to retailers in exchange for a waiver of the inventory storage fees to which the retailers would otherwise be entitled). This effective forfeiture, in turn, will result in a total volume pumped that is less than the total volume sold (they may be equal, but the amount pumped can never exceed the amount sold). It is also likely that, for all closed pools, some retailers will have delivered more gallons than they sold, while others will have delivered fewer than they sold. An inventory rebalancing module within the exchange may then balance inventories by shifting either appropriate gasoline or cash payments between retailers.

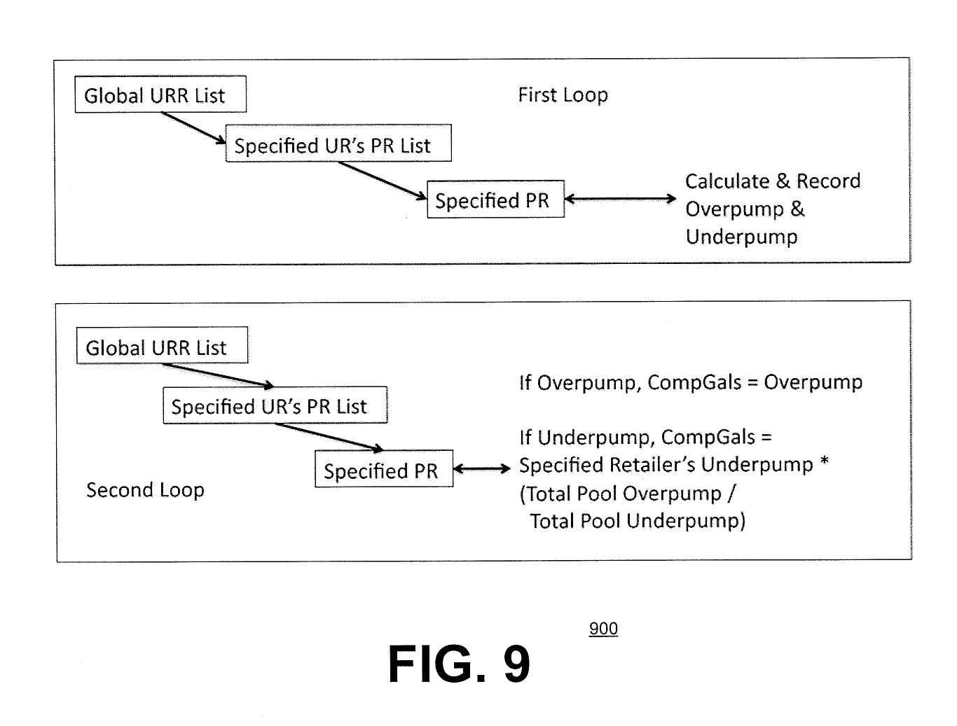

In this exemplary embodiment, one particular rebalancing algorithm was adopted, and the flow of calculations performed by the particular rebalancing algorithm is depicted by FIG. 9. The rebalancing algorithm includes the following steps:
1. Access the global URR List. For each retailer:
   a. Access the retailer's User/Pool List. For each specific pool:
      i. Record amount of overpumping or underpumping in the UPR.
      ii. Access the global PR List.
         1. Extract the appropriate PR.
         2. Update information in the PR.
   b. Close initial loop with all retailers identified as overpumpers or underpumpers for each pool, and with all PRs recording amounts of overpump and underpump.
2. Access the global URR List. For each retailer:
   a. Access the retailer's User/Pool List. For each pool:
      i. If the user overpumped, the user is entitled to compensation for the number of gallons overpumped (CompGals).
      ii. If the user underpumped:
         1. The user keeps the amount underpumped.
         2. The user owes compensation for a number of gallons given by the volume of its own underpump (Specified Retailer's Underpump), times the ratio of the pool total overpump to the pool total underpump (Total Pool Overpump/Total Pool Underpump). Note that, as explained above, this ratio should be less than or equal to 1.0. As a result, retailers who underpump owe compensation for a number of gallons less than or equal to the number of gallons retained.
   b. Retrieve a uniform per-gallon price from a pre-designated external source.
   c. Flow cash as appropriate among retailers.

This exchange of cash payments as specified by the rebalancing algorithm closes the pool and completes the flow of information through the embodiment. However, it will be appreciated that this rebalancing algorithm, and this exemplary embodiment as a whole, were not presented to demonstrate all aspects of the invention but merely to illustrate a working example of the general principles described above.

It will be appreciated that the extension of this exemplary system to a front-end CCUFS exchange system that incorporates secondary sales, options, or complex derivatives would be straightforward to one skilled in the art. Anyone holding a contract for unconditional future delivery could offer that contract, in whole or in part, for resale, thereby creating a secondary market. Furthermore, the secondary market, once created, further allows parties not in possession of contracts for future delivery to short such contracts and/or to write and sell put and call options and/or complex derivatives. The effects of such an extension are limited to the front end CCUFS exchange system. At the close of trading, prior to delivery, all unexercised options will expire, and all contracts will be in the hands of consumers authorized to take physical delivery. From that point forward, the back end distribution network will operate in a unified matter for all contract holders, whether they purchased those contracts on the primary or secondary markets, or through the exercise of an option or a derivative.

It will thus be appreciated that the described system and method facilitates the completion of CCUFSs of retail goods via a CCUFS exchange, in combination with a distribution network for taking delivery on completed contracts. It will also be appreciated, however, that the foregoing methods and embodiments are merely examples of the inventive principles, and that these illustrate only preferred techniques.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A system for processing contracts for conditional or unconditional forward sales (CCUFSs) of retail goods and distributing the retail goods, the system comprising:
a CCUFS exchange, comprising:
at least one networked computing device for transmitting information to and receiving information from a user computing device over a network, the received information comprising user submissions input by a user into the user computing device; and
at least one database for storing account information corresponding to the user, contract information corresponding to user submissions input into the exchange by users, and distribution information corresponding to delivery of the retail goods to users; and
a retail distribution network comprising a plurality of retail distribution points, wherein a retail distribution point further comprises:
a retail distribution point interface accessible to users for communicating with the exchange.

2. The system of claim 1, wherein the user submissions comprise offers to sell and offers to buy including type, price, quantity, place of delivery, and time of delivery terms.

3. The system of claim 2, wherein offers to sell having similar place of delivery, time of delivery, and type terms are pooled together into pools.

4. The system of claim 3, wherein the CCUFS exchange further comprises an inventory rebalancing module for processing distribution-related imbalances.

5. The system of claim 4, wherein processing distribution-related imbalances comprises facilitating transfers of at least one of retail goods and money between a plurality of retailers corresponding to retail distribution points that under-delivered to retailers corresponding to a retail distribution points that over-delivered, wherein the amount of money transferred is based on at least one of the amount of retail goods that were under-delivered and the amount of retail goods that were over-delivered.

6. The system of claim 4, wherein the inventory rebalancing module is further configured to facilitate purchases from a first retailer to a second retailer at a predetermined price.

7. The system of claim 6, wherein the predetermined price is determined based on at least one of an agreed price between the retailers, an external source of prices for the retail good, and a price set by the exchange based on a valuation of the retail good.

8. The system of claim 1, wherein user submissions are input by a user through a contract writing interface, wherein the contract writing interface is based on the type of contract offer being input.

9. The system of claim 8, wherein the user is one of a retail consumer, a retail seller, and a trader.

10. The system of claim 1, wherein the retail good is gasoline.

11. A method for processing contracts for conditional or unconditional forward sales (CCUFSs) of retail goods at a computer-implemented CCUFS exchange and distributing the retail goods at retail distribution points, the method comprising:
receiving inputs from users, at the CCUFS exchange, corresponding to CCUFS offers;
storing the offers at the CCUFS exchange;
filling the offers to generate filled CCUFSs, wherein the retail goods are distributed to the users at the retail distribution points based on terms of the filled CCUFSs; and
receiving information at the exchange over the network from the retail distribution points corresponding to the distribution of the retail goods to the users at the retail distribution points based on terms of the filled CCUFSs.

12. The method of claim 11, wherein filling the offers further comprises one of:
matching at least one existing offer with a newly received offer;
matching at least two existing offers with each other; and
receiving user input corresponding to the user choosing to fill an existing offer.

13. The method of claim 11, wherein the offers include type, quantity, price, place of delivery, and time of delivery terms.

14. The method of claim 13, the method further comprising:
designating contract offers having similar type, place of delivery, and time of delivery terms as part of a pool.

15. The method of claim 14, the method further comprising:
compensating for under-delivery and over-delivery by the retail distribution points.

16. The method of claim 15, wherein compensating for under-delivery and over-delivery by the retail distribution points further comprises:
facilitating purchases of the retail goods from retailers corresponding to retail distribution points that over-delivered from retailers corresponding to retail distribution points that under-delivered, wherein the purchases are subject to a predetermined price.

17. A system for processing contracts for conditional or unconditional forward sales (CCUFSs) of retail goods and distributing the retail goods, comprising a CCUFS exchange having a tangible, non-transient computer-readable memory with computer-executable instructions, the computer-executable instructions comprising:
instructions for receiving inputs from users over a network corresponding to CCUFS offers relating to the retail goods;
instructions for storing the offers at a database;
instructions for filling the offers to generate filled CCUFSs, wherein the retail goods are distributed to the users at the retail distribution points based on terms of the filled CCUFSs; and
instructions for receiving information at the exchange over the network from the retail distribution points corresponding to the distribution of the retail goods to the users at the retail distribution points based on terms of the filled CCUFSs.

18. The system of claim 17, wherein the instructions for filling the offers further comprise at least one of:
instructions for matching at least one offer with a newly received offer;
instructions for matching at least two existing offers with each other; and
instructions for receiving user input corresponding to the user choosing to fill an existing offer.

19. The system of claim 17, wherein the futures-related contract offers include type, quantity, price, place of delivery, and time of delivery terms and the computer-executable instructions further comprise:
instructions for designating contract offers having similar type, place of delivery, and time of delivery terms as part of a pool, and
instructions for compensating for under-delivery and over-delivery by the retail distribution points.

20. The system of claim 19, wherein the instructions for compensating for under-delivery and over-delivery by the retail distribution points further comprise:
instructions for facilitating purchases of the retail goods from retailers corresponding to retail distribution points that over-delivered from retailers corresponding to retail distribution points that under-delivered, wherein the purchases are subject to a predetermined price.

21. A method for pooling and rebalancing contracts for conditional or unconditional forward sales (CCUFSs) of retail goods at a computer-implemented CCUFS exchange, the method comprising:
designating, at the CCUFS exchange, a plurality of CCUFS offers meeting predetermined criteria as part of a pool;
receiving information regarding distribution of retail goods pursuant to filled CCUFSs corresponding to the pool; and
performing inventory rebalancing of at least one of retail goods and money based on the received information, wherein the at least one of retail goods and money is exchanged between at least two retailers based on a result of the performed inventory balancing.

22. The method of claim 21, wherein a plurality of CCUFS offers meets the predetermined criteria if the plurality of contract offers have the same type, place of delivery, and time of delivery terms.

23. The method of claim 21, wherein performing inventory rebalancing based on the received information further comprises:
determining an amount of at least one of retail goods and money to be transferred from a first retailer of the pool to a second retailer of the pool based on the amount of retail goods distributed at the first and second retailers corresponding to filled contract offers corresponding to the pool.

24. An apparatus for providing a retail distribution point interface at a retail distribution point in a retail distribution network corresponding to a computer-implemented exchange for contracts for conditional or unconditional forward sales (CCUFS exchange). the apparatus comprising a tangible non-transient computer-readable medium having computer-executable instructions stored thereon, the computer-executable instructions comprising:
instructions for receiving a retail good distribution request;
instructions for accessing at least one database on the CCUFS exchange over a network to determine whether the retail good distribution request is valid;
instructions for approving the retail good distribution request if the retail good distribution request is determined to be valid; and
instructions for transmitting information corresponding to the distribution of retail goods pursuant to an approved retail good distribution request to the CCUFS exchange over the network.

25. The apparatus of claim 24, wherein the apparatus is one of connected to and integrated into a gas pump.
